(19) United States
(12) Patent Application Publication
(10) Pub. No.: US 2020/0004827 A1
(43) Pub. Date: Jan. 2, 2020

(54) GENERALIZED LINEAR MIXED MODELS FOR GENERATING RECOMMENDATIONS

(71) Applicant: Microsoft Technology Licensing, LLC, Redmond, WA (US)

(72) Inventors: Konstantin Salomatin, San Francisco, CA (US); Gungor Polatkan, San Jose, CA (US)

(21) Appl. No.: 16/020,384

(22) Filed: Jun. 27, 2018

(51) Int. Cl. G06F 17/30; G06N 99/00; H04L 29/08; G06F 3/0482

(52) U.S. Cl. CPC G06F 17/3005; G06F 17/30867; H04L 51/22; H04L 67/306; G06F 3/0482; G06N 99/005

(57) ABSTRACT

Techniques for improving online content recommendations using generalized linear mixed models are disclosed herein. In some embodiments, a generalized mixed model, comprising a baseline model, a user-based model, and a course-based model, is used to generate scores for each one of a plurality of candidate online courses. The baseline model is a generalized linear model based on profile information of a target user and metadata of the candidate online course, the user-based model is a random effects model based on a history of online activity by the target user directed towards reference online courses having metadata related to the metadata of the candidate online course, and the course-based model is a random effects model based on a history of online activity directed towards the candidate online course by a plurality of reference users having profile information related to the profile information of the target user.

### TECHNICAL FIELD

The present application relates generally to methods and systems of reducing electronic resource consumption for using generalized linear mixed effect models for generating recommendations of online content.

### BACKGROUND

Generalized linear models suffer from a lack of personalization, particularly when used in the area of information retrieval, such as generating recommendations of online content for users of an online service, resulting in the most relevant content being downgraded in favor of irrelevant content the display area, such as in search results. As a result, users of such an information retrieval system spend a longer time in their search for content and request a computer system to perform actions with respect to the irrelevant content, leading to excessive consumption of electronic resources, such as a wasteful use of processing power and computational expense associated with generating and displaying irrelevant content, and a wasteful use of network bandwidth associated with transmission of messages based on irrelevant content.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of recommendation system, in accordance with an example embodiment.

FIG. 4 illustrates a graphical user interface (GUI) displaying a landing page including recommendations for online courses, in accordance with an example embodiment.

FIG. 5 illustrates a GUI displaying a search results page including recommendations for online courses, in accordance with an example embodiment.

FIG. 6 illustrates a GUI displaying a video of an online course, in accordance with an example embodiment.

FIG. 7 illustrates a stored history of user actions with respect to online courses, in accordance with an example embodiment.

FIG. 8 is a flowchart illustrating a method of using a generalized linear mixed model for generating recommendations for online courses, in accordance with an example embodiment.

FIG. 9 is a flowchart illustrating a method of selecting a subset of online courses, in accordance with an example embodiment.

FIG. 10 is a block diagram illustrating a mobile device, in accordance with some example embodiments.

FIG. 11 is a block diagram of an example computer system on which methodologies described herein may be executed, in accordance with an example embodiment.

### DETAILED DESCRIPTION

Example methods and systems of reducing electronic resource consumption using generalized linear mixed effect models for generating recommendations are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. Some technical effects of the system and method of the present disclosure are to reduce electronic resource consumption using generalized linear mixed models for generating recommendations. In some example embodiments, a specially-configured computer system conserves processing power, computational expense, and network bandwidth by using specially-configured generalized linear mixed models to generate the most relevant recommendations of online content. Additionally, other technical effects will be apparent from this disclosure as well.

Any of the features disclosed herein with respect to the term “member” may also apply to other users of an online service who may not technically be registered members of the online service, and vice-versa.

In some example embodiments, operations are performed by a computer system (or other machine) having a memory and at least one hardware processor, with the operations comprising: extracting profile information from a profile of a target user stored in a database of a social networking service; for each one of a plurality of candidate online courses available for consumption via the social networking service, accessing metadata of the candidate online course; for each one of the plurality of candidate online courses, generating a corresponding score based on a generalized linear mixed model comprising a baseline model, a user-based model, and a course-based model, the baseline model being a generalized linear model based on the profile information of the target user and the metadata of the candidate online course, the user-based model being a random effects model based on a history of online activity by the target user directed towards reference online courses having metadata determined to be related to the metadata of the candidate online course, and the course-based model being a random effects model based on a history of online activity directed towards the candidate online course by a plurality of reference users having profile information determined to be related to the profile information of the target user; selecting a subset of online courses from the plurality of candidate online courses based on the corresponding scores of the subset of online courses; and causing a corresponding selectable user interface element for each one of the selected subset of online courses to be displayed on the computing device of the target user, the corresponding selectable user interface element being configured to enable the consumption of the corresponding online course via the social networking service in response to its selection. In some example embodiments, the baseline model is a fixed effects model.

In some example embodiments, the plurality of candidate online courses comprise videos available to be viewed by users of the social networking service. In some example embodiments, the profile information comprises at least one of skills, interests, industry, employment history, and educational background. In some example embodiments; the metadata of the candidate online course comprises one or more of at least one skill associated with the candidate online course and at least one subject category associated with the candidate online course.

In some example embodiments, the online activity directed towards the reference online courses comprises at least one of selecting a user interface element indicating an interest by the target user in consuming the reference online courses, selecting a user interface element indicating an instruction to play a video file or an audio file of the reference online courses, consuming a portion of the video file or the audio file of the reference online courses, and consuming all of the video file or the audio file of the reference online courses, and the online activity directed towards the candidate online course comprises at least one of selecting a user interface element indicating an interest by the reference users in consuming the candidate online course, selecting a user interface element indicating an instruction to play a video file or an audio file of the candidate online course, consuming a portion of the video file or the audio file of the candidate online course, and consuming all of the video file or the audio file of the candidate online course.

In some example embodiments; the selecting the subset of online courses comprises: ranking the plurality of candidate online courses based on their corresponding scores; and selecting the subset of online courses based on the ranking of the plurality of candidate online courses.

In some example embodiments; the causing the corresponding selectable user interface element for each one of the selected subset of online courses to be displayed comprises causing the corresponding selectable user interface element for each one of the selected subset of online courses to be displayed via at least one communication channel from a group of communication channels consisting of: a personalized data feed for the target user; a listing of search results on a search results page of the social networking service; and an e-mail transmitted to the target user.

In some example embodiments, the operations further comprise selecting a communication channel to use in displaying the corresponding selectable user interface element for each one of the selected subset of online courses from amongst a plurality of communication channels, wherein the generating of the corresponding score is further based on the selected communication channel.

In some example embodiments, the operations further comprise: receiving an indication of a selection by the target user of the corresponding selectable user interface element for at least one of the selected subset of online courses; storing the indication of the selection by the target user of the corresponding selectable user interface element in the database of the social networking service; and using a machine learning algorithm to modify at least one of the baseline model, the user-based model, and the course-based model based on the stored indication of the selection by the target user of the corresponding selectable user interface element.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

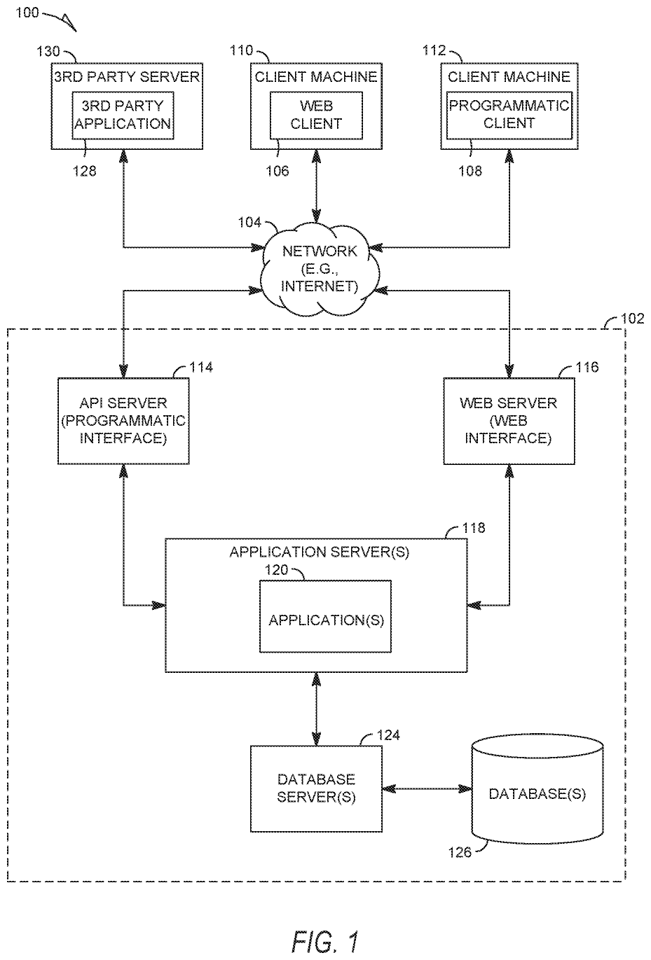

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

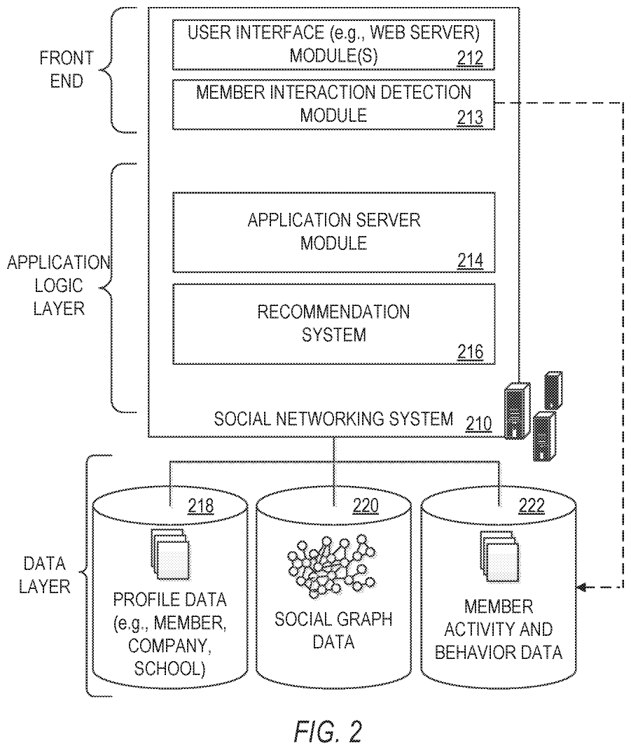

In some embodiments, the networked system 102 may comprise functional components of a social networking service. FIG. 2 is a block diagram showing the functional components of a social networking system 210, including a data processing module referred to herein as an recommendation system 216, for use in social networking system 210, consistent with some embodiments of the present disclosure. In some embodiments, the recommendation system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the recommendation system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family, members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to inter or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the recommendation system 216.

In some embodiments, databases 218, 220, and 222 may be incorporated into database(s) 126 in FIG. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the recommendation system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

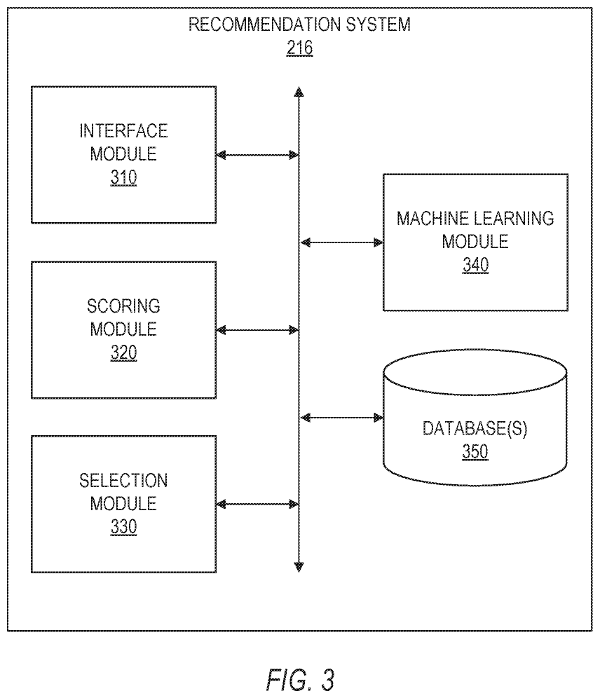

FIG. 3 is a block diagram illustrating components of the recommendation system 216, in accordance with an example embodiment. In some embodiments, the recommendation system 216 comprises any combination of one or more of an interface module 310, a scoring module 320, a selection module 330, a machine learning module 340, and one or more database(s) 350. The modules 310, 320, 330, and 340, and the database(s) 350 can reside on a computer system, or other machine, having a memory and at least one processor (not shown). In some embodiments, the modules 310, 320, 330, and 340, and the database(s) 350 can be incorporated into the application server(s) 118 in FIG. 1, In some example embodiments, the databases) 350 is incorporated into database(s) 126 in FIG. 1 and can include any combination of one or more of databases 218, 220, and 222 in FIG. 2. However, it is contemplated that other configurations of the modules 310, 320, 330, and 340, and the database(s) 350, are also within the scope of the present disclosure.

In some example embodiments, one or more of the modules 310, 320, 330, and 340 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, 330, and 340 is configured to receive user input. For example, one or more of the modules 310, 320, 330, and 340 can present one or more GUI elements (e.g., drop-down menu, selectable buttons, text field) with which a user can submit input.

In some example embodiments, one or more of the modules 310, 320, 330, and 340 is configured to perform various communication functions to facilitate the functionality described herein, such as by communicating with the social networking system 210 via the network 104 using a wired or wireless connection. Any combination of one or more of the modules 310, 320, 330, and 340 may also provide various web services or functions, such as retrieving information from the third party servers 130 and the social networking system 210. Information retrieved by the any of the modules 310, 320, 330, and 340 may include profile data corresponding to users and members of the social networking service of the social networking system 210.

Additionally, any combination of one or more of the modules 310, 320, 330, and 340 can provide various data functionality, such as exchanging information with database(s) 350 or servers. For example, any of the modules 310, 320, 330, and 340 can access member profiles that include profile data from the database(s) 350, as well as extract attributes and/or characteristics from the profile data of member profiles. Furthermore, the one or more of the modules 310, 320, 330, and 340 can access social graph data and member activity and behavior data from database(s) 350, as well as exchange information with third party servers 130, client machines 110, 112, and other sources of information.

In some example embodiments, the recommendation system 216 is configured to generate, employ, and modify generalized linear mixed models. The generalized linear mixed models of the present disclosure are an improvement on generalized linear models. In addition to linear or logistic regression on overall data, the generalized linear models of the present disclosure add new entity-level regression models to a generalized linear model, which introduces personalization for entities, such as users and courses. In cases where data is abundant, such as in use cases where a user is searching through an extremely large volume of courses, the generalized linear mixed models of the present disclosure provide a significant improvement in relevance of search results and other types of recommendations, as they can be used to build predictive entity-level models for entity personalization.

In some example embodiments, the generalized linear mixed models of the present disclosure use model variants to improve course recommendation relevance. For example, given historical user interactions with online courses, user profile information, and course metadata, a ranking model may be built to generate the most relevant recommendations for online courses for a particular user. In order to add entity-centralized personalization to these models, generalized linear mixed models including a generalized linear baseline model and one or more random effects models for different entities, including a user-based model and a course-based model, may be used.

One advantageous technical effect of the features of the present disclosure include is deep personalization. For example, the generalized linear mixed models of the present disclosure introduce deep personalization for entities including the users and the online courses. Other advantageous technical effects of the features of the present disclosure include, but are not limited to, scalability and speed. For example, model training and scoring for the generalized linear mixed models of the present disclosure are faster and more scalable than for other models.

In some example embodiments, the interface module 310 is configured to detect activity by a user on, or otherwise directed to, a page of an online service. For example, the interface module 310 may detect when a user visits or otherwise accesses a page of an online service, such as a home page or a landing page of an online service. The interface module 310 may also detect when a user submits a search query, such as when a user submits one or more search terms to be used in a search for online courses available for consumption via the online service. In some example embodiments, the detection by the interface module 310 of activity by a user on a page of an online service acts triggers the performance of any combination of one or more of the operations of the scoring module 320, the selection module 330, and the machine learning module 340 disclosed herein.

In some example embodiments, the scoring module 320 is configured to extract profile information from a profile of a target user stored in a database of a social networking service. The profile information may comprise any profile data stored in the database 218 in FIG. 2. In some example embodiments, the profile information comprises at least one of skills, interests, industry, employment history, and educational background. However, other types of profile data may be extracted as well.

In some example embodiments, the scoring module 320 is configured to, for each one of a plurality of candidate online courses available for consumption via the social networking service, access metadata of the candidate online course. A candidate online course may comprise any online educational content that is available for consumption by users via a social networking service. Examples of such content include, but are not limited to video-based courses that are available to be viewed by users of the social networking service and audio-based courses that are available to be listened to by users of the social networking service. The metadata of the candidate online course may comprise any data that can be used to describe or categorize the candidate online course. In some example embodiments, the metadata of the candidate online course comprises one or more of at least one skill associated with the candidate online course (e.g., Java programming for a candidate online course about software programming) and at least one subject category associated with the candidate online course (e.g., patent law for a candidate online course teaching patent law). However, other types of metadata are also within the scope of the present disclosure, including, but not limited to, author of the candidate online course.

In some example embodiments, the scoring module 320 is configured to, for each one of the plurality of candidate online courses, generate a corresponding score based on a generalized linear mixed model comprising a baseline model, a user-based model, and a course-based model. The idea of the generalized linear mixed model approach employed by the scoring module 320 is to learn and use user-based models (or per-user models) based on the engagements of a particular user with online courses, and course-based models (or per-course models) based on user engagements with a particular course. In some example embodiments, the generalized linear mixed model is formulated as follows:

g(E(click|m,c))=w^{T}x_{mc}+αₘ^{T}x_{c}+β_{c}^{T}xₘ.

in the example embodiment of the generalized linear mixed model above, m the member (or user) index, c is the course index, and the first component w^{T}x_{mc} is the baseline model, which may be a logistic regression baseline. This baseline model is a generalized linear model based on the profile information of the target user and the metadata of the candidate online course. In some example embodiments, the baseline model is a fixed effects model that compares the profile information of the target user with the metadata of the candidate online course in order to determine similarity between the two. For example, for a target user whose profile information indicates that the target user is working as a software engineer, a candidate online course that has metadata indicating that the candidate online course is related to software engineering may be scored higher than a candidate online course that does not include metadata indicating that the candidate online course is related to software engineering but is rather related to playing the guitar.

In the example embodiment of the generalized linear mixed model above, the second component αₘ^{T}x_{c} is the user-based model, which is configured to boost the course categories of online courses that the target user engaged with in the past. In the user-based model, x_{c} represents the subset of course features with which the target user interacted. In some example embodiments, the user-based model is a random effects model based on a history of online activity by the target user directed towards reference online courses having metadata determined to be related to the metadata of the candidate online course. For example, for a candidate online course having metadata indicating that the subject of the candidate online course is software engineering, the user-based model determines the level of interaction by the target user with online courses that are determined to be related to the subject of software engineering, and assigns a higher score to the candidate online course as the level of interaction increases, such that the more often and/or to a higher degree that the target user interacted with clicked on, viewed, etc.) online courses that are related to software engineering, the higher the score the user-based model would assign to the candidate online course for that particular user.

In some example embodiments, the online activity directed towards the online courses that is evaluated and considered by the user-based model is generating the score for the candidate online course comprises at least one of selecting a user interface element indicating an interest by the target user in consuming the reference online courses, selecting a user interface element indicating an instruction to play a video file or an audio file of the reference online courses, consuming a portion of the video file or the audio file of the reference online courses, and consuming all of the video file or the audio file of the reference online courses. However, other types of online activity by the target user towards the online courses are also within the scope of the present disclosure.

In the example embodiment of the generalized linear mixed model above, the last component β_{c}^{T}xₘ is the course-based model, which is configured to boost the titles of users who previously engaged with the course. In some example embodiments, the course-based model is a random effects model based on a history of online activity directed towards the candidate online course by a plurality of reference users having profile information determined to be related to the profile information of the target user. For example, for a candidate online course, the course-based model determines the level of interaction by users that are determined to be sufficiently similar to the target user based on a comparison of their profile information, and assigns a higher score to the candidate online course as the level of interaction with that particular candidate online course for those similar users increases, such that the more often and/or to a higher degree that similar users interacted with (e.g., clicked on, viewed, etc.) that particular candidate online course, the higher the score the course-based model would assign to the candidate online course for the target user.

The user-based model (per-user model) is particularly useful in resolving issues for engaged learners, while the course-based models are particularly useful to better model online courses because the number of online courses may be relatively small and each online course may have a lot of interactions by users.

In some example embodiments, the selection module 330 is configured to select a subset of online courses from the plurality of candidate online courses for recommendation to the target user based on the corresponding scores of the subset of online courses. In some example embodiments, the selecting the subset of online courses comprises ranking the plurality of candidate online courses based on their corresponding scores, and selecting the subset of online courses based on the ranking of the plurality of candidate online courses. For example, the selection module 330 may select the highest ranking candidate online courses (e.g., the twenty-five candidate online courses with the highest scores) for recommendation to the target user. In some example embodiments, the selection module 330 selects all of the candidate online courses having a corresponding score that meets a predetermined threshold score (e.g., all candidate online courses having a corresponding score of 0.85 or higher)

In some example embodiments, the interface module 310 is configured to causing a corresponding selectable user interface element for each one of the selected subset of online courses to be displayed on the computing device of the target user, the corresponding selectable user interface element being configured to enable the consumption of the corresponding online course via the social networking service in response to its selection. In some example embodiments, the interface module 310 causes display of the corresponding selectable user interface element for each one of the selected subset of online courses via at least one communication channel from a group of communication channels consisting of a personalized data feed for the target user, a listing of search results on a search results page of the social networking service, and an e-mail transmitted to the target user. However, it is contemplated that other types of communication channels may be used for display of the corresponding selectable user interface element for each one of the selected subset of online courses.

In some example embodiments, the interface module 310 is configured to select a communication channel to use in displaying the corresponding selectable user interface element for each one of the selected subset of online courses from amongst a plurality of communication channels. The scoring module 320 may be configured to generate the corresponding score of a candidate online course based on the selected communication channel. For each candidate online course, a different score may be generated for each communication channel based on the level of interaction resulting from recommendation of online courses via that communication channel, and then the communication channel with the highest score may be selected for use in displaying the corresponding selectable user interface element for the selected subset of online courses. In this way, the recommendation system 216 may determine and user the most effective communication channel for a particular user and a particular online course. In some example embodiments, the selection module 330 is configured to select different subsets of online courses from the plurality of candidate online courses for recommendation to the target user for different communication channels based on the corresponding scores of the online courses being based, at least in part, on the communication channel to be used. For example, the selection module 330 may select online courses A, B, and C for recommendation via e-mail, but select online courses A, B, and D for recommendation via a personalized feed on the a landing page. The selection module 330 may select the online courses being recommended and the number of online courses being recommended based on the particular communication channel to be used for providing the recommendation to the user.

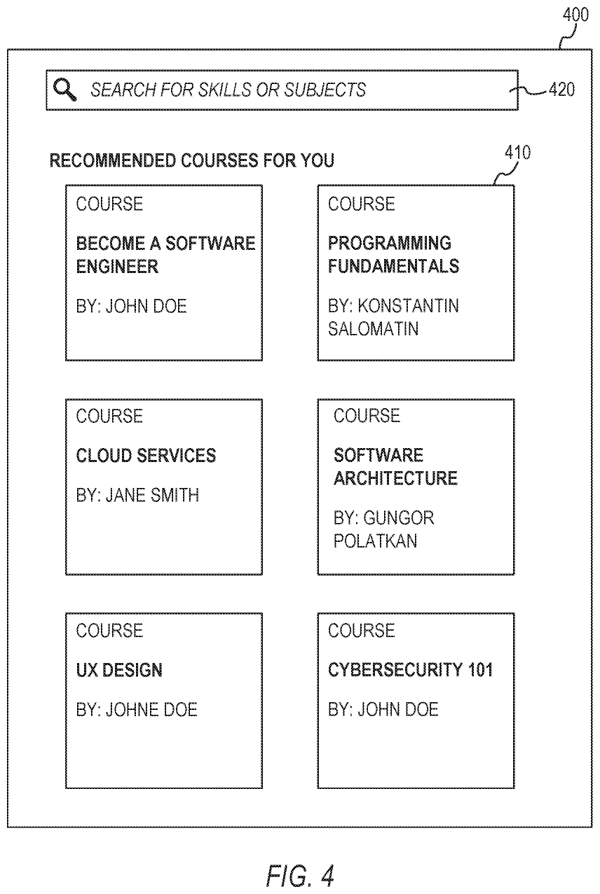

FIG. 4 illustrates a graphical user interface (GUI) 400 displaying a landing page including recommendations 410 for online courses, in accordance with an example embodiment. The recommendations 410 comprise selectable user interface elements for each one of the selected subset of online courses. Each recommendation 410 may include information about the corresponding online course, such as the title and author. Other types of information, including, but not limited to, duration and rating, may also be included in the recommendation 410.

Each selectable user interface element of the recommendation 410 may be configured to trigger an interaction event between the user selecting the user interface element and the online course corresponding to the selected user interface element. For example, selection of one of the selectable user interface elements may trigger a playing of the online course (e.g., playing of a video file or an audio file) or navigation to another page or another state of the same page in which the user is provided with additional information about the online course or with selectable options to watch or otherwise consume the online course.

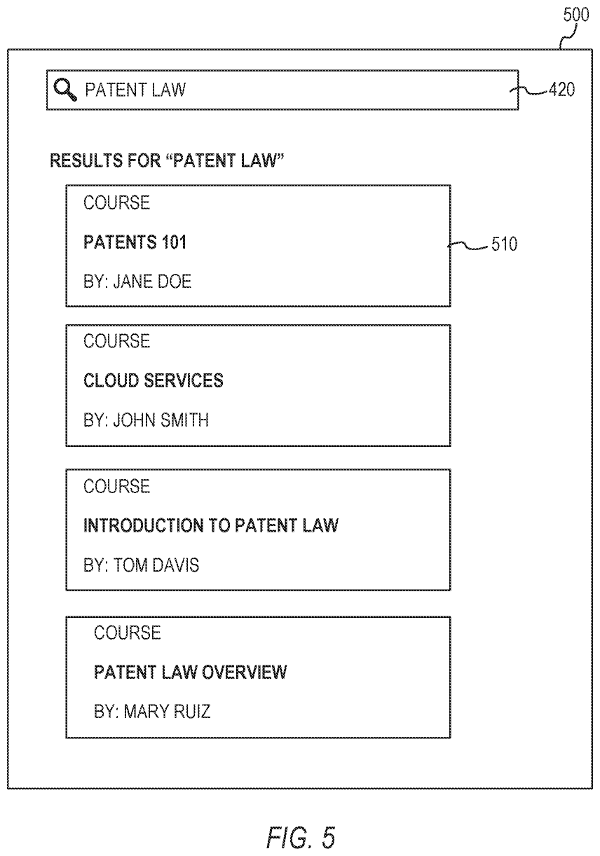

The GUI 400 may also display one or more user interface elements 420 configured to enable the user to submit a search query for searching for online courses, such as by entering keyword search terms into a search field. FIG. 5 illustrates a GUI 500 displaying a search results page including recommendations 510 for online courses, in accordance with an example embodiment. The recommendations 510 may include the same features as the recommendations 410 in FIG. 4, including information about the corresponding online course and comprising a selectable user interface element configured to trigger an interaction event between the user selecting the user interface element and the online course corresponding to the selected user interface element. In the example shown in FIG. 5, the user has submitted a search query “PATENT LAW” via search field 420, and the recommendation system 216 has generated search results made up of recommended relevant online courses related to the search query “PATENT LAW.” The recommendations 410 displayed in FIG. 4 and the recommendations 510 displayed in FIG. 5 may be displayed in an order that is based on the corresponding scores of their corresponding online courses. For example, the higher the score of an online course, the more priority the recommendation 410 or 510 of the corresponding online course may be given in its display, such as being displayed in a higher position than recommendations of online courses having lower scores.

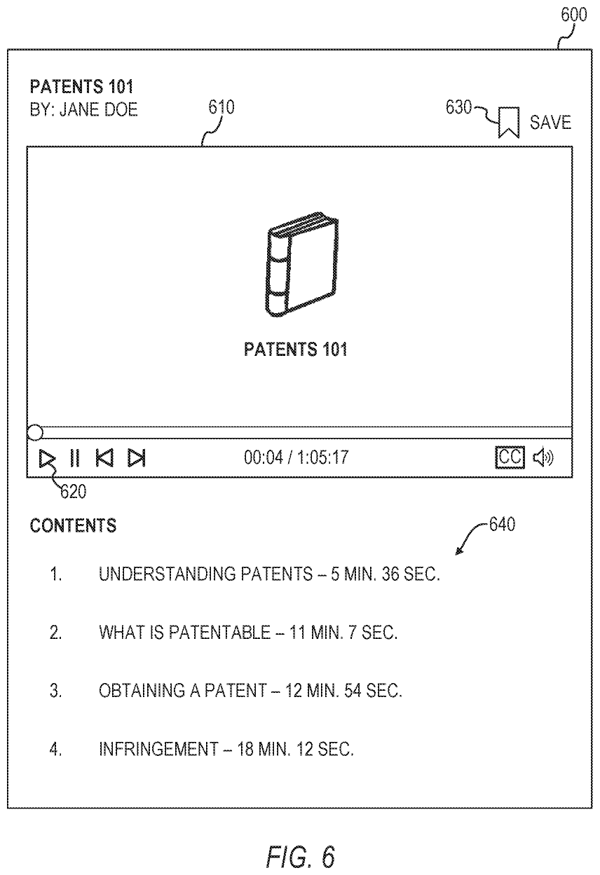

FIG. 6 illustrates a GUI 600 displaying a video 610 of an online course, in accordance with an example embodiment. GUI 600 may be displayed in response to a selection of a selectable user interface element corresponding to the online course, such as a selection of one of the selectable user interface elements of recommendations 410 in FIG. 4 or recommendations 510 in FIG. 5. In some example embodiments, the user may interact with the video 610 of the online course in a variety of ways. For example, the user may play and watch the video 610 by selecting a user interface element 620, such as a selectable play button. The user may also save the video 610 to a list of videos to watch at a later time by selecting a user interface element 630, such as a selectable save button.

In some example embodiments, there are different types and stages of interaction by the user with an online course. For example, the user may select a recommendation 410 or 510 of an online course to view more information about the online course, the user may select to save the online course for future viewing, and the user may watch the online course. In some example embodiments, the online course is divided into multiple sections or portions 640. The user can view only a subset of the entire set of sections 640 or can view the entire set of sections. Each viewing of a section 640 of the online course can increase the user's level of interaction with the online course, which can then be used by the user-based model and the course-based model in determining the level of engagement of users with online courses, as previously discussed.

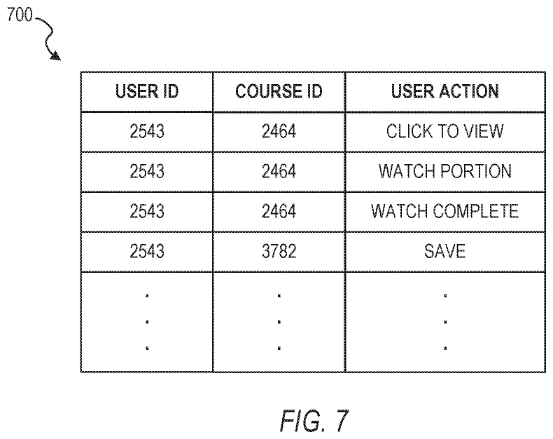

FIG. 7 illustrates a stored history 700 of user actions with respect to online courses, in accordance with an example embodiment. In some example embodiments, the stored history 700 comprises indications of online courses each user has engaged with via a user action, and the different types of user actions the user has used to engage the online course. For example, the stored history 700 may comprise a record of each interaction a user associated with user ID 2542 has had with any online course. This stored history 700 may be stored in the database(s) 350 and retrieved by the scoring module 320 when using the generalized linear mixed model to generate scores for the candidate online courses.

In some example embodiments, the machine learning module 340 is configured to receive an indication of a selection by the target user of the corresponding selectable user interface element for the selected subset of online courses displayed to the target user, store the indication of the selection by the target user of the corresponding selectable user interface element in the database of the social networking service, and then use a machine learning algorithm to modify at least one of the baseline model, the user-based model, and the course-based model based on the stored indication of the selection by the target user of the corresponding selectable user interface element. In this respect, the machine learning module 340 may use the online activity of users resulting from recommendations of the online courses to train the model(s) used in generating recommendations for online courses.

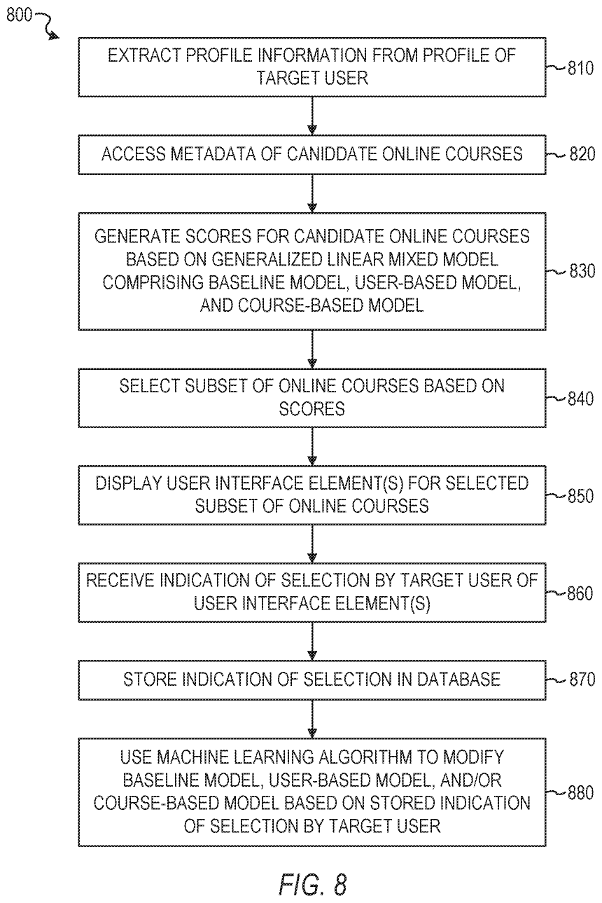

FIG. 8 is a flowchart illustrating a method 800 of using a generalized linear mixed model for generating recommendations for online courses, in accordance with an example embodiment. The method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the recommendation system 216 of FIGS. 2-3, or any combination of one or more of its modules, as described above.

At operation 810, the recommendation system 216 extracts profile information from a profile of a target user stored in a database of a social networking service. The profile information may comprise any of the profile data in database 218 of FIG. 2. In some example embodiments, the profile information comprises at least one of skills, interests, industry, employment history, and educational background. However, other types of profile data are also within the scope of the present disclosure.

At operation 820, the recommendation system 216, for each one of a plurality of candidate online courses available for consumption via the social networking service, accesses metadata of the candidate online course. In some example embodiments, the plurality of candidate online courses comprise videos available to be viewed by users of the social networking service. In some example embodiments, the metadata of the candidate online course comprises one or more skills associated with the candidate online course and/or one or more subject categories associated with the candidate online course.

At operation 830, the recommendation system 216, for each one of the plurality of candidate online courses, generates a corresponding score based on a generalized linear mixed effects model comprising a baseline model, a user-based model, and a course-based model. In some example embodiments, the baseline model is a generalized linear model based on the profile information of the target user and the metadata of the candidate online course, the user-based model is a random effects model based on a history of online activity by the target user directed towards reference online courses having metadata determined to be related to the metadata of the candidate online course, and the course-based model is a random effects model based on a history of online activity directed towards the candidate online course by a plurality of reference users having profile information determined to be related to the profile information of the target user. In some example embodiments, the online activity directed towards the reference online courses comprises at least one of selecting a user interface element indicating an interest by the target user in consuming the reference online courses, selecting a user interface element indicating an instruction to play a video file or an audio file of the reference online courses, consuming a portion of the video file or the audio file of the reference online courses, and consuming all of the video file or the audio file of the reference online courses, and the online activity directed towards the candidate online course comprises at least one of selecting a user interface element indicating an interest by the reference users in consuming the candidate online course, selecting a user interface element indicating an instruction to play a video file or an audio file of the candidate online course, consuming a portion of the video file or the audio file of the candidate online course, and consuming all of the video file or the audio file of the candidate online course. In some example embodiments, the baseline model is a fixed effects model.

At operation 840, the recommendation system 216 selects a subset of online courses from the plurality of candidate online courses based on the corresponding scores of the subset of online courses. In some example embodiments, the recommendation system 216 uses a threshold score to select the subset of online courses, such that any candidate online courses having scores that do not meet the threshold score are not selected, and any candidate online courses having scores that do meet the threshold score are selected. In some example embodiments, the recommendation system 216 uses a ranking of the candidate online courses by their corresponding scores to select the subset of online courses, such as by selecting the top twenty-five ranking online courses.

At operation 850, the recommendation system 216 causes a corresponding selectable user interface element for each one of the selected subset of online courses to be displayed on the computing device of the target user. In some example embodiments, the corresponding selectable user interface element is configured to enable the consumption of the corresponding online course via the social networking service in response to its selection. In some example embodiments, the causing the corresponding selectable user interface element for each one of the selected subset of online courses to be displayed comprises causing the corresponding selectable user interface element for each one of the selected subset of online courses to be displayed via at least one communication channel from a group of communication channels consisting of a personalized data feed for the target user, a listing of search results on a search results page of the social networking service, and an e-mail transmitted to the target user.

At operation 860, the recommendation system 216 receives an indication of a selection by the target user of the corresponding selectable user interface element for at least one of the selected subset of online courses. For example, if the target user clicks or taps on a selectable user interface element corresponding to online course A (e.g., to view the online course), then the recommendation system 216 received an indication of the selection of the selectable user interface element corresponding to online course A.

At operation 870, the recommendation system 216 stores the indication of the selection by the target user of the corresponding selectable user interface element in the database of the social networking service. In the example used above for operation 860, the recommendation system 216 would store the indication of the selection of the corresponding selectable user interface element for online course A.

At operation 880, the recommendation system 216 uses a machine learning algorithm to modify at least one of the baseline model, the user-based model, and the course-based model based on the stored indication of the selection by the target user of the corresponding selectable user interface element. In this respect, the recommendation system 216 may use the online activity of the target user resulting from recommendations of the online courses to train the models used in generating the recommendations for online courses.

It is contemplated that any of the other features described within the present disclosure can be incorporated into the method 800.

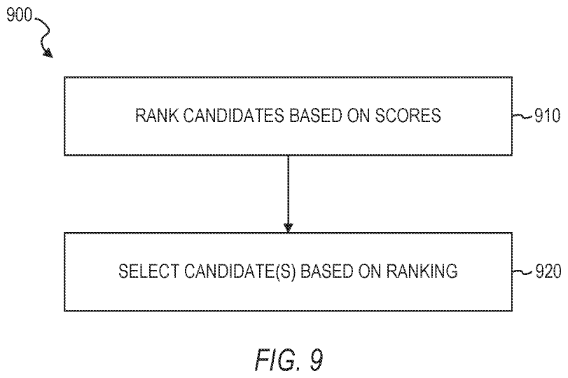

FIG. 9 is a flowchart illustrating a method 900 of selecting a subset of online courses, in accordance with an example embodiment. The method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the recommendation system 216 of FIGS. 2-3, or any combination of one or more of its modules, as described above.

At operation 910, the recommendation system 216 ranks the plurality of candidate online courses based on their corresponding scores. For example, the recommendation system 216 may rank the candidate online courses in descending order from the highest scoring candidate online course to the lowest scoring candidate online course. At operation 920, the recommendation system 216 selects the subset of online courses based on the ranking of the plurality of candidate online courses. For example, the recommendation system 216 may select the top N-ranked candidate online courses, where N is a positive integer.

It is contemplated that any of the other features described within the present disclosure can be incorporated into the method 900.

### Example Mobile Device

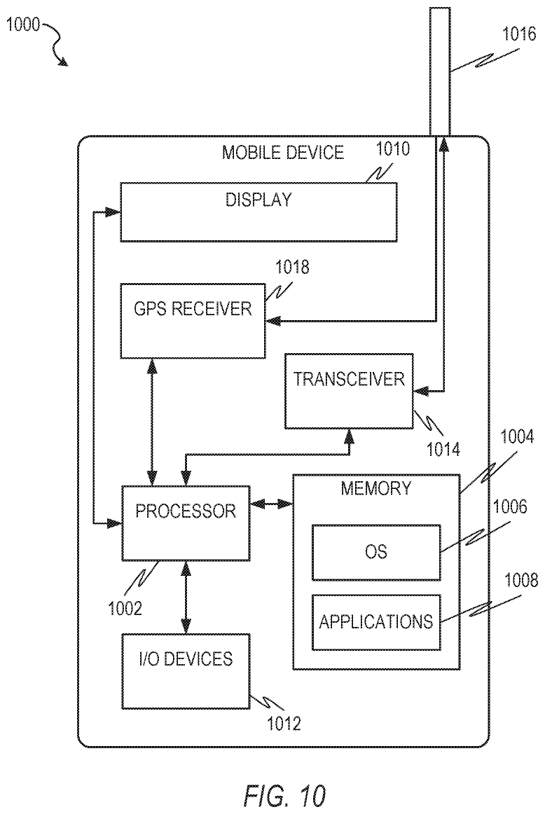

FIG. 10 is a block diagram illustrating a mobile device 1000, according to an example embodiment. The mobile device 1000 can include a processor 1002. The processor 1002 can be any of a variety of different types of commercially available processors suitable for mobile devices 1000 (for example, an XScale architecture microprocessor, a Microprocessor without Interlocked Pipeline Stages (MIPS) architecture processor, or another type of processor). A memory 1004, such as a random access memory (RAM), a Hash memory, or other type of memory, is typically accessible to the processor 1002. The memory 1004 can be adapted to store an operating system (OS) 1006, as well as application programs 1008, such as a mobile location-enabled application that can provide location-based services (LBSs) to a user. The processor 1002 can be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 can be coupled to a transceiver 1014 that interfaces with an antenna 1016. The transceiver 1014 can be configured to both transmit and receive cellular network signals, wireless data signals, or other types of signals via the antenna 1016, depending on the nature of the mobile device 1000. Further, in some configurations, a GPS receiver 1018 can also make use of the antenna 1016 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily, configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially, processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

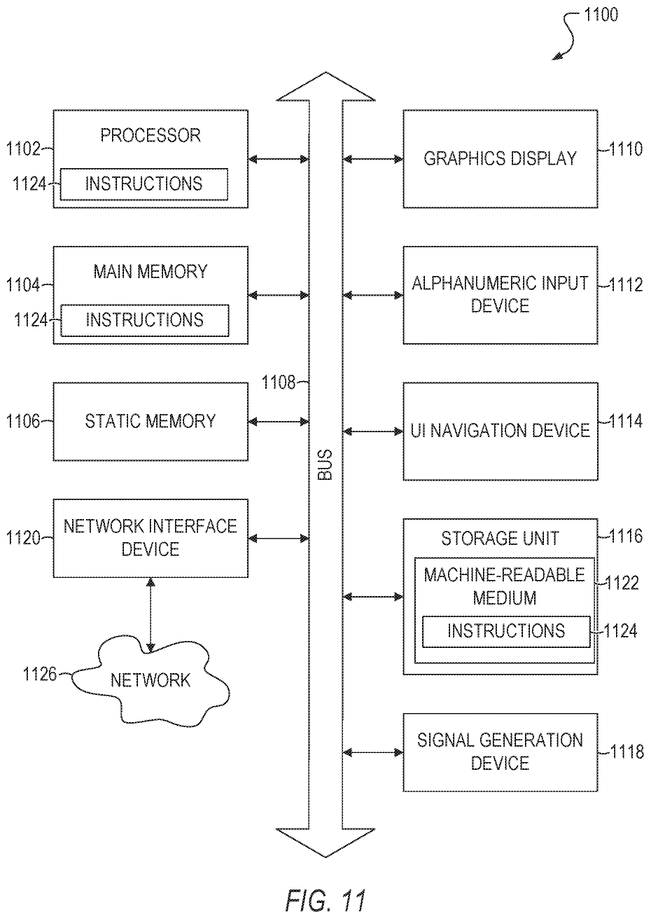

FIG. 11 is a block diagram of an example computer system 1100 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a graphics display unit 1110 (e.g., a liquid crystal display (LCD) or a cathode ray tube (CRT)). The computer system 1100 also includes an alphanumeric input device 1112 (e.g., a keyboard or a touch-sensitive display screen), a user interface (UI) navigation device 1114 (e.g., a mouse), a storage unit 1116, a signal generation device 1118 (e.g., a speaker) and a network interface device 1120.

### Machine-Readable Medium

The storage unit 1116 includes a machine-readable medium 1122 on which is stored one or more sets of instructions and data structures (e.g., software) 1124 embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions (e.g., instructions 1124) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
extracting, by a computer system having a memory and at least one hardware processor, profile information from a profile of a target user stored in a database of a social networking service;
for each one of a plurality of candidate online courses available for consumption via the social networking service; accessing, by the computer system, metadata of the candidate online course;
for each one of the plurality of candidate online courses, generating, by the computer system, a corresponding score based on a generalized linear mixed model comprising a baseline model, a user-based model, and a course-based model, the baseline model being a generalized linear model based on the profile information of the target user and the metadata of the candidate online course, the user-based model being a random effects model based on a history of online activity by the target user directed towards reference online courses having metadata determined to be related to the metadata of the candidate online course, and the course-based model being a random effects model based on a history of online activity directed towards the candidate online course by a plurality of reference users having profile information determined to be related to the profile information of the target user;
selecting, by the computer system, a subset of online courses from the plurality of candidate online courses based on the corresponding scores of the subset of online courses; and
causing, by the computer system, a corresponding selectable user interface element for each one of the selected subset of online courses to be displayed on the computing device of the target user, the corresponding selectable user interface element being configured to enable the consumption of the corresponding online course via the social networking service in response to its selection.

2. The computer-implemented method of claim 1, wherein the plurality of candidate online courses comprise videos available to be viewed by users of the social networking service.

3. The computer-implemented method of claim 1, wherein the baseline model is a fixed effects model.

4. The computer-implemented method of claim 1, wherein the profile information comprises at least one of skills, interests, industry, employment history, and educational background.

5. The computer-implemented method of claim 1, wherein the metadata of the candidate online course comprises one or more of at least one skill associated with the candidate online course and at least one subject category associated with the candidate online course.

6. The computer-implemented method of claim 1, wherein:
the online activity directed towards the reference online courses comprises at least one of selecting a user interface element indicating an interest by the target user in consuming the reference online courses, selecting a user interface element indicating an instruction to play a video file or an audio file of the reference online courses, consuming a portion of the video file or the audio file of the reference online courses, and consuming all of the video file or the audio file of the reference online courses; and
the online activity directed towards the candidate online course comprises at least one of selecting a user interface element indicating an interest by the reference users in consuming the candidate online course, selecting a user interface element indicating an instruction to play a video file or an audio file of the candidate online course; consuming a portion of the video file or the audio file of the candidate online course, and consuming all of the video file or the audio file of the candidate online course.

7. The computer-implemented method of claim 1, wherein the selecting the subset of online courses comprises:
ranking the plurality of candidate online courses based on their corresponding scores; and
selecting the subset of online courses based on the ranking of the plurality of candidate online courses.

8. The computer-implemented method of claim 1, wherein the causing the corresponding selectable user interface element for each one of the selected subset of online courses to be displayed comprises causing the corresponding selectable user interface element for each one of the selected subset of online courses to be displayed via at least one communication channel from a group of communication channels consisting of:
a personalized data feed for the target user;
a listing of search results on a search results page of the social networking service; and
an e-mail transmitted to the target user.

9. The computer-implemented method of claim 1, further comprising selecting, by the computer system, a communication channel to use in displaying the corresponding selectable user interface element for each one of the selected subset of online courses from amongst a plurality of communication channels, wherein the generating of the corresponding score is further based on the selected communication channel.

10. The computer-implemented method of claim 1, further comprising:
receiving, by the computer system, an indication of a selection by the target user of the corresponding selectable user interface element for at least one of the selected subset of online courses;
storing, by the computer system, the indication of the selection by the target user of the corresponding selectable user interface element in the database of the social networking service; and
using, by the computer system, a machine learning algorithm to modify at least one of the baseline model, the user-based model, and the course-based model based on the stored indication of the selection by the target user of the corresponding selectable user interface element.

11. A system comprising:
at least one hardware processor; and
a non-transitory machine-readable medium embodying a set of instructions that, when executed by the at least one hardware processor, cause the at least one processor to perform operations, the operations comprising:
extracting profile information from a profile of a target user stored in a database of a social networking service;
for each one of a plurality of candidate online courses available for consumption via the social networking service, accessing metadata of the candidate online course;
for each one of the plurality of candidate online courses, generating a corresponding score based on a generalized linear mixed model comprising a baseline model, a user-based model, and a course-based model, the baseline model being a generalized linear model based on the profile information of the target user and the metadata of the candidate online course, the user-based model being a random effects model based on a history of online activity by the target user directed towards reference online courses having metadata determined to be related to the metadata of the candidate online course, and the course-based model being a random effects model based on a history of online activity directed towards the candidate online course by a plurality of reference users having profile information determined to be related to the profile information of the target user;
selecting a subset of online courses from the plurality of candidate online courses based on the corresponding scores of the subset of online courses; and
causing a corresponding selectable user interface element for each one of the selected subset of online courses to be displayed on the computing device of the target user, the corresponding selectable user interface element being configured to enable the consumption of the corresponding online course via the social networking service in response to its selection.

12. The system of claim 11, wherein the plurality of candidate online courses comprise videos available to be viewed by users of the social networking service.

13. The system of claim 11, wherein the profile information comprises at least one of skills, interests, industry, employment history, and educational background.

14. The system of claim 11, wherein the metadata of the candidate online course comprises one or more of at least one skill associated with the candidate online course and at least one subject category associated with the candidate online course.

15. The system of claim 11, wherein:
the online activity directed towards the reference online courses comprises at least one of selecting a user interface element indicating an interest by the target user in consuming the reference online courses, selecting a user interface element indicating an instruction to play a video file or an audio file of the reference online courses, consuming a portion of the video file or the audio file of the reference online courses, and consuming all of the video file or the audio file of the reference online courses; and
the online activity directed towards the candidate online course comprises at least one of selecting a user interface element indicating an interest by the reference users in consuming the candidate online course, selecting a user interface element indicating an instruction to play a video file or an audio file of the candidate online course, consuming a portion of the video file or the audio file of the candidate online course, and consuming all of the video file or the audio file of the candidate online course.

16. The system of claim 11, wherein the selecting the subset of online courses comprises:
ranking the plurality of candidate online courses based on their corresponding scores; and
selecting the subset of online courses based on the ranking of the plurality of candidate online courses.

17. The system of claim 11, wherein the causing the corresponding selectable user interface element for each one of the selected subset of online courses to be displayed comprises causing the corresponding selectable user interface element for each one of the selected subset of online courses to be displayed via at least one communication channel from a group of communication channels consisting of:
a personalized data feed for the target user;
a listing of search results on a search results page of the social networking service; and
an e-mail transmitted to the target user.

18. The system of claim 11, wherein the operations further comprise selecting a communication channel to use in displaying the corresponding selectable user interface element for each one of the selected subset of online courses from amongst a plurality of communication channels, wherein the generating of the corresponding score is further based on the selected communication channel.

19. The system of claim 11, wherein the operations further comprise:
receiving an indication of a selection by the target user of the corresponding selectable user interface element for at least one of the selected subset of online courses;
storing the indication of the selection by the target user of the corresponding selectable user interface element in the database of the social networking service; and
using a machine learning algorithm to modify at least one of the baseline model, the user-based model, and the course-based model based on the stored indication of the selection by the target user of the corresponding selectable user interface element.

20. A non-transitory machine-readable medium embodying a set of instructions that, when executed by at least one hardware processor, cause the processor to perform operations, the operations comprising:
extracting profile information from a profile of a target user stored in a database of a social networking service;
for each one of a plurality of candidate online courses available for consumption via the social networking service, accessing metadata of the candidate online course;
for each one of the plurality of candidate online courses, generating a corresponding score based on a generalized linear mixed model comprising a baseline model, a user-based model, and a course-based model, the baseline model being a generalized linear model based on the profile information of the target user and the metadata of the candidate online course, the user-based model being a random effects model based on a history of online activity by the target user directed towards reference online courses having metadata determined to be related to the metadata of the candidate online course, and the course-based model being a random effects model based on a history of online activity directed towards the candidate online course by a plurality of reference users having profile information determined to be related to the profile information of the target user;
selecting a subset of online courses from the plurality of candidate online courses based on the corresponding scores of the subset of online courses; and
causing a corresponding selectable user interface element for each one of the selected subset of online courses to be displayed on the computing device of the target user, the corresponding selectable user interface element being configured to enable the consumption of the corresponding online course via the social networking service in response to its selection.
